(19) United States
(12) Patent Application Publication
(10) Pub. No.: US 2010/0051842 A1
(43) Pub. Date: Mar. 4, 2010

(54) ELECTROPNEUMATIC PRESSURE TRANSDUCER

(75) Inventor: Chantal Mertens, Cologne (DE)

Correspondence Address: DARBY & DARBY P.C., P.O. BOX 770, Church Street Station, New York, NY, 10008-0770, US

(73) Assignee: Pierburg GmbH, Neuss (DE)

(21) Appl. No.: 12/515,310

(22) PCT Filed: Sep. 11, 2007
(86) PCT No.: PCT/EP2007/059510

§ 371 Date: May 18, 2009

(30) Foreign Application Priority Data
Nov. 16, 2006 (DE) 102006054040.9

(51) Int. Cl. F16K 31/02

(52) U.S. Cl. 251/129.08

(57) ABSTRACT

An electropneumatic pressure transducer. The electropneumatic pressure transducer includes a double-seated valve with a first valve seat disposed between a control pressure chamber and an underpressure connector, and a second valve seat disposed between an atmospheric-pressure connector and the control pressure chamber, and a movable plunger-type armature; a valve closure member; a membrane coupled to the plunger-type armature; and an electromagnetic circuit generating an electromagnetic force acting on the plunger-type armature. The control pressure chamber is selectively connected to one of the atmospheric-pressure connector and the underpressure connector to generate a mixed pressure in the control pressure chamber dependent on a position of the plunger-type armature. The position of the plunger-type armature is dependant on the electromagnetic force and on a pneumatic force acting on the membrane. In a rest state without current flow through the electromagnetic circuit, the valve closure member is seated on the first valve seat and is disposed at a distance from the second valve seat.

### CROSS REFERENCE TO PRIOR APPLICATIONS

This application is a U.S. National Phase application under 35 U.S.C. §371 of International Application No. PCT/EP2007/059510, filed on Sep. 11, 2007, and which claims benefit to German Patent Application No. 10 2006 054 040.9, filed on Nov. 16, 2006. The International Application was published in German on May 22, 2008 as WO 2008/058778 A1 under PCT Article 21(2).

### FIELD

The present invention relates to an electropneumatic pressure transducer comprising a valve means which includes a double-seated valve having a first valve seat arranged between a control pressure chamber and an underpressure connector, and a second valve seat arranged between an atmospheric-pressure connector and said control pressure chamber, wherein, in dependence on the position of a plunger-type armature, the control pressure chamber can be selectively connected to said atmospheric-pressure connector or to said underpressure connector for generating a mixed pressure in the control pressure chamber, the position of said plunger-type armature depending on an electromagnetic force, acting on the plunger-type armature, of an electromagnetic circuit, and further depending on a pneumatic force acting on a membrane coupled to the plunger-type armature.

### BACKGROUND

The pressure generated in the control chamber by an electropneumatic pressure transducer of the above type is used, for instance, to operate automatic actuators such as e.g. vacuum actuators, which in turn can be used for operation of exhaust-gas return valves, exhaust-gas flaps or the like.

A pressure transducer of the above type is described in DE 41 10 003 C1. The double-seated valve of the pressure transducer described therein comprises a valve plate biased against the valve seats by a spring force and thus serving as a valve closure member. When powered, the solenoid, which is normally driven by pulse-width modulation, will have the effect that the plunger-type armature together with the second valve seat is pulled, between the atmospheric-pressure connector and the control chamber, in the direction towards the solenoid, whereby the valve plate will be lifted off from the first valve seat between the control pressure chamber and the underpressure connector and the underpressure is allowed to enter the control pressure chamber. As a result, the pressure in the control pressure chamber will drop, causing the membrane to be pressurized in the opposite direction, i.e. towards the first valve seat. Depending on the amount of the underpressure existing in the control pressure chamber, the resultant force from this pneumatic force and from the electromagnetic force is large enough to cause the plunger-type armature and thus the valve plate to abut against the second valve seat while the first valve seat is pushed farther in a direction away from the solenoid, thereby establishing a connection to the atmospheric-pressure connector. By this clocked shifting of the plunger-type armature in the upward and downward directions, a mixed pressure is generated in the control pressure chamber, which is dependent on the magnitude of the effective current in the electromagnetic circuit. A problem in this pressure transducer resided in that, during operation with constant frequency, clocked direct voltage and variable switch-on/switch-off period ratio, the valve means tended to vibrate, with the consequence of a marked increase in air consumption because, when the second valve seat was opened, a leakage of underpressure from the control pressure chamber to the atmospheric pressure took place although the solenoid had not been driven correspondingly.

Thus, to reduce the air consumption, DE 42 05 565 C2 described an electropneumatic pressure transducer of a similar configuration wherein, however, the valve plate comprised portions differing in elasticity. Particularly, the region cooperating with the connecting line to the underpressure was produced to have a high elastic deformability and thus a higher switching hysteresis than in the region of the connecting line to the atmospheric pressure. This technique was intended to prevent an undesired lifting of the valve plate from the second valve seat.

However, the above technique has not turned out to be sufficiently successful, and it has become evident that, particularly in the de-energized condition of the solenoid, there still exists an undesirably high air consumption so that an underpressure generator for producing the required vacuum will be subjected to a higher workload, this in turn causing an unnecessary increase of the current consumption in the entire internal combustion engine and, consequently, of the fuel consumption.

### SUMMARY

It is an aspect of the present invention to provide an electro-pneumatic pressure transducer wherein, in the de-energized condition, the air consumption in case of external vibrational stress is reliably reduced by a simple technique.

In an embodiment, the present invention provides for an electropneumatic pressure transducer. The electropneumatic pressure transducer includes a double-seated valve with a first valve seat disposed between a control pressure chamber and an underpressure connector, and a second valve seat disposed between an atmospheric-pressure connector and the control pressure chamber, and a movable plunger-type armature; a valve closure member; a membrane coupled to the plunger-type armature; and an electromagnetic circuit generating an electromagnetic force acting on the plunger-type armature. The control pressure chamber is selectively connected to one of the atmospheric-pressure connector and the underpressure connector to generate a mixed pressure in the control pressure chamber dependent on a position of the plunger-type armature. The position of the plunger-type armature is dependant on the electromagnetic force and on a pneumatic force acting on the membrane. In a rest state without current flow through the electromagnetic circuit, the valve closure member is seated on the first valve seat and is disposed at a distance from the second valve seat. Such a displacement of the valve seats relative to each other is effective to reduce the air consumption while accomplishing a correspondingly high damping of the electropneumatic transducer, since there will be caused no undesired opening periods of the underpressure connector to the control chamber during oscillation movements of the plunger-type armature.

### BRIEF DESCRIPTION OF THE DRAWINGS

The present invention is described in greater detail below on the basis of embodiments and of the drawings in which.

FIG. 1 is a sectional lateral view of an electropneumatic transducer of the state of the art.

FIG. 2a is a sectional view of a detail in the region of the valve means of the electropneumatic pressure transducer of FIG. 1 in the rest position in the state without current flow.

FIG. 2b is a sectional view of said detail in the region of the valve means of FIG. 2a in a situation of oscillating stress and subsequent movement of the plunger-type armature in the direction towards the solenoid.

FIG. 2c is a sectional view of said detail in the region of the valve means of FIG. 2a in a situation of oscillating stress and subsequent movement of the plunger-type armature in the direction away from the solenoid.

FIG. 3a is a sectional view of said detail in the region of a valve means of an electropneumatic transducer according to the present invention in the rest position in the state without current flow.

FIG. 3b is a sectional view of said detail in the region of the valve means of FIG. 3a in a situation of oscillating stress and subsequent movement of the plunger-type armature in the direction towards the solenoid.

FIG. 3c is a sectional view of said detail in the region of the valve means of FIG. 3a in a situation of oscillating stress and subsequent movement of the plunger-type armature in the direction away from the solenoid.

### DETAILED DESCRIPTION

According to an embodiment of the present invention modifying the above arrangement, it is provided that, in the rest position in the state without current flow, the distance of said valve closure member from said second valve seat corresponds to a maximum vibration amplitude of the plunger-type armature.

Such a maximum oscillation amplitude can be defined e.g. by testing or by precise computation of the entire existing oscillation system. The oscillation system herein comprises the mass of the plunger-type armature and of a spring arranged under the valve plate, the rolling resistance of the membrane, the damping oil film between the plunger-type armature and the slide-bearing sleeve, as well as the oscillating stresses to be expected.

It is evident that, in a valve of the above configuration, backflow of undesired underpressure from the control chamber to the atmospheric-pressure connector is prevented in that, when no current is fed to the solenoid, no underpressure is allowed to enter the control chamber. Thus, in the state where no current is fed to such an electropneumatic pressure transducer, the air consumption will be reliably minimized, thereby reducing the fuel consumption of an internal combustion engine.

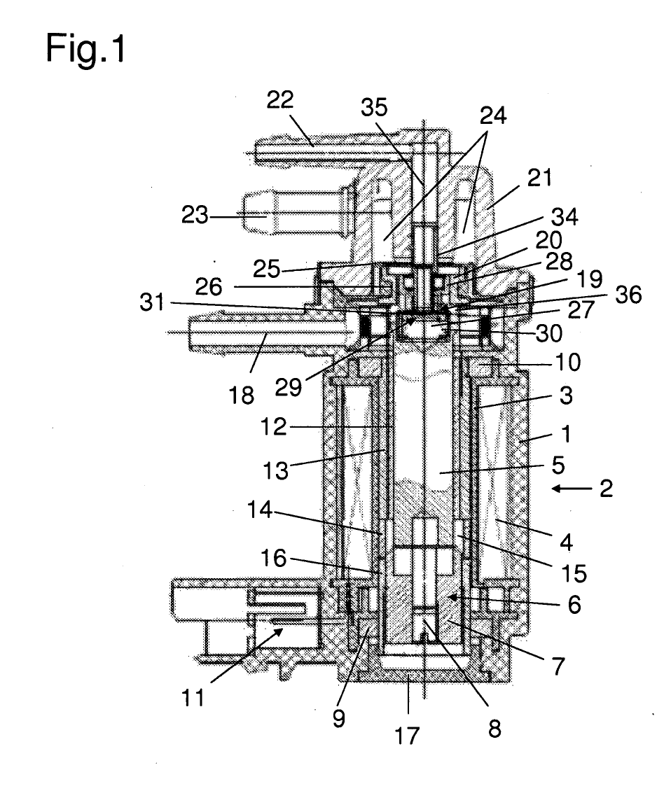

The electropneumatic pressure transducer illustrated in FIG. 1 comprises a housing 1 with an electromagnetic circuit 2 arranged therein, said electromagnetic circuit including a coil 4 wound about a coil holder 3, a plunger-type armature 5, a two-part core 6 having a first, outer core portion 7 and a second, inner core portion 8 arranged coaxially to said first core portion 7, as well as a reflux metal sheet 9 and a yoke 10.

Housing 1 is provided with a connector plug 11 for electric contact to said coil 4. Said plunger-type armature 5 is supported in a slide-bearing sleeve 12 which is coaxially surrounded by a metal shell 13. Said metal shell 13 is fixedly connected to said yoke 10. Metal shell 13 is followed, axially in the direction towards core 6, by a plastic shell 14 arranged around a gap 15 between plunger-type armature 5 and core 6, in which gap the magnetic field for generating the axial movement of plunger-type armature 5 will be generated when current is supplied to coil 4. Plastic shell 14 in turn is followed by a second metal shell 16 formed with an inner thread for threaded engagement with said first, outer core portion 7 of core 6. Said second core portion 8 comprises, in addition to its outer thread, a through-going bore formed with an inner thread receiving the second core portion 8 in threaded engagement. Metal shell 16 further has its outer periphery provided with a fixed connection to said reflux metal sheet 9. The above components 4 to 16 constitute said magnetic circuit 2 in a known manner.

The threads on core 6 serve for adjusting the air gap between plunger-type armature 5 and the iron core 6 and thus for adjusting the magnetic characteristic, whereby the generation of force in the plunger-type armature 5 can be adjusted. In doing so, rotating of the first, outer core portion 7 will effect a relatively large change of the generated force, while rotating the second core portion 8 serves for fine adjustment.

To allow for the adjusting of said core portions 7,8, the axial end of housing 1 accommodating core 6 therein is open. After the desired gap has been set, housing 1 will be closed by a cover 17.

The other end of housing 1 is provided with an atmospheric-pressure connector 18 arranged in fluid connection to a valve means 19 situated in a plunger head 20 of plunger-type armature 5.

On this side, which is located opposite to core 6, housing 1 is closed by a housing head 21 including an underpressure connector 22 as well as a control-pressure connector 23 connected to a control pressure chamber 24, said connectors being also arranged in fluid connection to valve means 19.

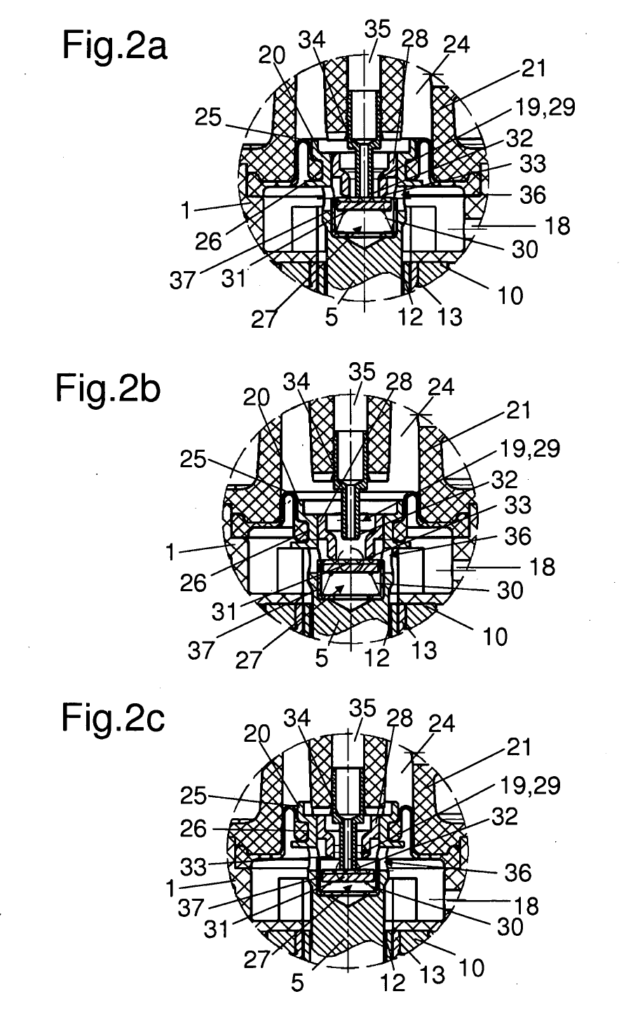

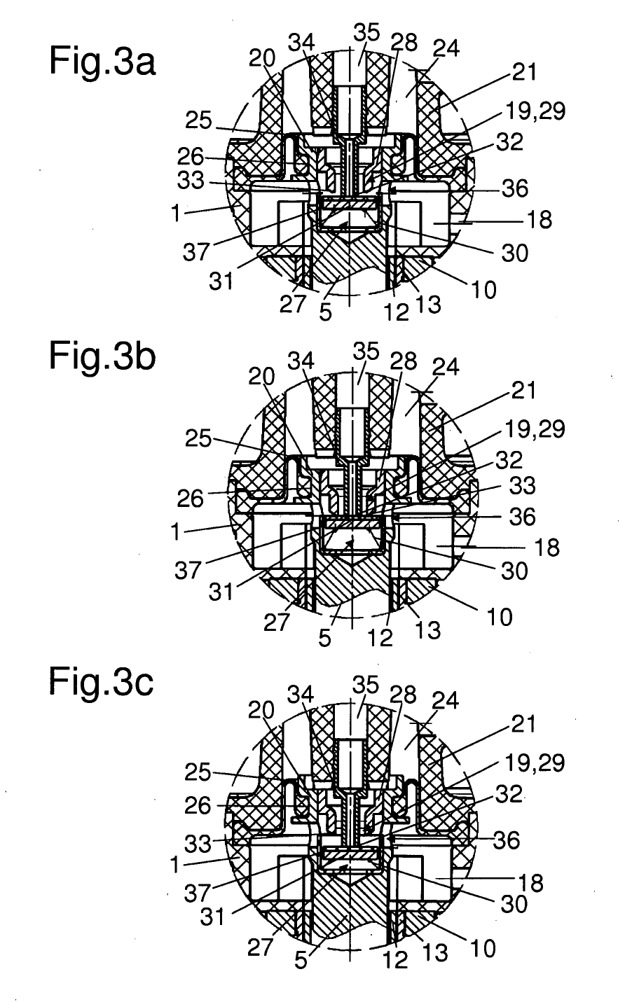

In FIGS. 2 and 3, valve means 19 is shown in enlarged detail. It can be seen that said housing head 21 and housing 1 have the radially outer edge of a roll membrane 25 clamped therebetween, the inner edge of said roll membrane being arranged in a groove 26 of plunger head 20, the latter including an axial blind hole 27 with a shell 28 pressed into it. Said shell 28 is provided with a bypass bore, not shown, of a very small diameter, or with a correspondingly small bypass slot by which, for reducing the switching hysteresis in the reversal points of the plunger-type armature 5, the control pressure chamber 24 is in fluid connection with the atmospheric-pressure connector 18.

Valve means 19 is configured in a known manner as a double-seated valve 29 and comprises a conical coil spring 30 located in said axial blind hole 27 and acting on a valve closure member, formed as a valve plate 31, in the direction towards two coaxial valve seats 32,33, the first valve seat 32 being formed on an underpressure tube 34 pressed into an underpressure bore 35 in housing head 21 and establishing a fluid connection to underpressure connector 22, and the second coaxial valve seat 33 being formed on that end of said pressed-in shell 28 which faces towards the plunger-type armature 5. These valve seats 32,33 are best seen in FIGS. 2 and 3. From these Figures, it is also evident that said blind hole 27 accommodates a shell 37 for guiding the valve plate 31, said shell being effective to protect the valve plate 31 from becoming wedged in radial throughgoing bores 36 formed on plunger head 20 and establishing a fluid connection between atmospheric-pressure connector 18 and valve means 19.

The electropneumatic pressure transducer is operative in that, in control pressure chamber 24, there will be generated a mixed pressure composed of the underpressure which can be introduced into control pressure chamber 24 via underpressure connector 22, and of the atmospheric pressure which can be introduced into control pressure chamber 24 via atmospheric-pressure connector 18.

The inflow of this underpressure or atmospheric pressure into control pressure chamber 24 is regulated by said double-seated valve 29.

The respective connection of control pressure chamber 24 is dependent on the arrangement of valve plate 31 and thus on the position of plunger-type armature 5. Accordingly, a movement of valve plate 31 is initiated only by activation of the solenoid, i.e. by current supplied to coil 4. By activation of the solenoid, the plunger-type armature 5 will be pulled in the direction towards the core 6, thereby causing the valve plate 3 1 to be lifted off from the first valve seat 32 and, consequently, allowing underpressure to flow into control pressure chamber 24. Thereby, a force is generated which will act on the membrane 25 and thus on the plunger-type armature 5 in the closing direction because the opposite side of the membrane 25 is subjected to atmospheric pressure. By the resultant movement of the armature in the opposite direction, the connection from underpressure connector 22 to control pressure chamber 24 will be interrupted again and, in the given case, valve seat 33 will be opened so that a connection to the atmospheric-pressure connector will be established and the force acting on the membrane will be reduced again. This process is repeated until a mixed pressure corresponding to the electromagnetic force is generated in control pressure chamber 24. There is generated a state of equilibrium in which the sum of all forces acting on the plunger-type armature 5 will become zero. These forces thus comprise the pulling force of the electromagnetic circuit 2 as well as the pneumatic forces acting on membrane 25.

In the process, the solenoid and respectively the coil 4 are fed by a clocked direct voltage in the form of a pulse-width-modulated signal. It is evident that, for each clock ratio of the pulse-width-modulated signal, another effective current is generated which will result in a magnetic force. For each magnetic force generated in this manner, the electropneumatic pressure transducer will in turn regulate itself to a new mixed pressure in control pressure chamber 24 and thus to a new state of equilibrium.

In FIG. 2, the currentless state of valve means 19 is illustrated. In this arrangement according to the state of the art, both valve seats 32,33 are closed by valve plate 31. As a result, a control underpressure can be built up already with low current flow, which is possible since valve plate 31 will become detached from valve seat 32 while control pressure chamber 24 is sealed against atmospheric-pressure connector 18.

In a situation, however, where an external oscillating excitation follows in the axial direction of the electropneumatic transducer, e.g. due to vibrations within an automobile, this will cause an undesired detachment of valve plate 31 from valve seat 32 upon movement of plunger-type armature 5 towards core 6 so that, as depicted in FIG. 2b, underpressure is allowed to flow into control pressure chamber 24. When the armature is subsequently moved in the opposite direction, valve plate 31 will again be seated on valve seat 32 and at the same time will become detached from second valve seat 33, so that a connection is established from the control pressure chamber 24 to the atmosphere. Thereby, the underpressure built up in control pressure chamber 24 will be discharged again towards the atmosphere. By continued repetition of this vibration process, a high air consumption is caused.

To solve the above problem, it is proposed according to the present invention as shown in FIG. 3a, that, in the rest position and in the state without current flow, the valve means 19 is positioned in such a manner that the first valve seat 32 is arranged in abutment against the valve plate 31 while the second valve seat 33, extending coaxially thereto, is arranged at a distance from the valve plate 31, thus establishing a connection between atmospheric-pressure connector 18 and control pressure chamber 24.

If, in a configuration of the above type, an external activation of plunger-type armature 5 takes place due to occurrence of vibrations, the valve plate 31—provided that the configuration is correct—will in the optimal case not be lifted off from the first valve seat 32 when the plunger-type armature 5 is moved in the direction towards core 6. To accomplish this, the distance which in the rest position exists between the valve plate and the second valve seat 33 is defined to effect a seated position of valve plate 31 on both valve seats 32,33 when the vibration amplitude is at its maximum. This position is shown in FIG. 2b. Here, the plunger-type armature 5 is in its maximally retracted position caused by external vibration. Thus, in control pressure chamber 24, there is generated no underpressure which would have to be reduced again during the subsequent movement of the armature in the direction towards housing head 21. Thus, there is also not generated any further air consumption. Should the oscillation amplitudes become larger, a significant reduction of the air consumption will be obtained nonetheless because the time periods and the frequency of an undesired opening of the first valve seat 32 are distinctly reduced.

Thus, in case of an optimum setting of the maximum armature oscillation amplitude, underpressure tube 34 in the currentless state is always seated on valve plate 31, whereby the underpressure supply is always closed and no undesired pressure will build up on the control pressure side. On the other hand, as a consequence, the functional characteristic of the electro-pneumatic transducer at the start of the movement will be shifted towards a higher duty cycle before a desired mixed pressure is built up in control pressure chamber 24, because—due to the current supply to coil 4 and the resultant movement of plunger-type armature 5—the gap between valve seat 33 and valve plate 31 will first have to be overcome before a control underpressure can be generated; this consequence, however, remains negligible in relation to the savings in air consumption.

Thus, there is provided an electropneumatic transducer which in comparison to known embodiments has a distinctly lower air consumption. Of course, for adjusting the gap between the second valve seat 33 and the valve plate 31, it is required to correctly define the rest position also in dependence on the installation of the electropneumatic valve because said rest position is dependent on the friction values of the electropneumatic transducer, the effective weight of plunger-type armature 5 as well as the rolling resistance of the membrane. Said adjustment can be performed either by corresponding computation or by corresponding tests.

It is evident that the electropneumatic transducer can also be configured in a different manner; thus, for instance, the valve plate 31 with spring 30 can be replaced by a bellows.

Of course, also the configuration of the electromagnetic circuit 2 can be altered without leaving the protective scope of the main claim. The main aspect of decisive importance in this regard is the mutual distance of the two valve seats in the axial direction, with the damping of the oscillation system being set in corresponding thereto.

The present application is not limited to embodiments described herein; reference should be had to the appended claims.

1-2. (canceled)

3. An electropneumatic pressure transducer comprising:
a double-seated valve with a first valve seat disposed between a control pressure chamber and an underpressure connector, and a second valve seat disposed between an atmospheric-pressure connector and the control pressure chamber, and a movable plunger-type armature;
a valve closure member;
a membrane coupled to the plunger-type armature; and
an electromagnetic circuit generating an electromagnetic force acting on the plunger-type armature;
wherein the control pressure chamber is selectively connected to one of the atmospheric-pressure connector and the underpressure connector to generate a mixed pressure in the control pressure chamber dependent on a position of the plunger-type armature, wherein the position of the plunger-type armature is dependant on the electromagnetic force and on a pneumatic force acting on the membrane,
wherein, in a rest state without current flow through the electromagnetic circuit, the valve closure member is seated on the first valve seat and is disposed at a distance from the second valve seat.

4. The electropneumatic pressure transducer as recited in claim 3, wherein, in the rest state, the distance of the valve closure member from the second valve seat corresponds to a maximum vibration amplitude of the plunger-type armature in the rest state.

5. A double-seated valve for an electropneumatic pressure transducer, the double-seated valve comprising:
a first valve seat disposed between a control pressure chamber and an underpressure connector;
a second valve seat disposed between an atmospheric-pressure connector and the control pressure chamber;
a movable plunger-type armature;
a valve closure member;
a membrane coupled to the plunger-type armature; and
an electromagnetic circuit generating an electromagnetic force acting on the plunger-type armature;
wherein the control pressure chamber is selectively connected to one of the atmospheric-pressure connector and the underpressure connector to generate a mixed pressure in the control pressure chamber dependent on a position of the plunger-type armature, wherein the position of the plunger-type armature is dependant on the electromagnetic force and on a pneumatic force acting on the membrane,
wherein, in a rest state without current flow through the electromagnetic circuit, the valve closure member is seated on the first valve seat and is disposed at a distance from the second valve seat.

6. The double-seated valve as recited in claim 5, wherein, in the rest state, the distance of the valve closure member from the second valve seat corresponds to a maximum vibration amplitude of the plunger-type armature in the rest state.
